(19) United States
(12) Patent Application Publication
(10) Pub. No.: US 2022/0082103 A1
(43) Pub. Date: Mar. 17, 2022

(54) VACUUM PUMP

(71) Applicant: Edwards Japan Limited, Chiba (JP)

(72) Inventor: Takashi Kabasawa, Chiba (JP)

(21) Appl. No.: 17/419,523

(22) PCT Filed: Dec. 24, 2019
(86) PCT No.: PCT/JP2019/050887

§ 371 Date: Jun. 29, 2021

(30) Foreign Application Priority Data
Jan. 10, 2019 (JP) 2019-002971

(51) Int. Cl. F04D 19/04; F04D 29/58

(52) U.S. Cl. CPC F04D 19/042; F05D 2210/12; F04D 29/5846; F04D 29/5826

(57) ABSTRACT

Decane (C10H22) is sprayed as a mist from spray nozzles toward a rotor blade via a supply pipe and communication passages. Since decane has a boiling point of 174° C. at atmospheric pressure, the decane is a liquid at normal temperature and normal pressure. On the other hand, the pressure inside a turbomolecular pump is in a substantially vacuum state of about 100 Pa, and the boiling point of decane at this pressure is 14° C. Thus, although the pressure is high and the decane is in a liquid state until the decane is sprayed, when the decane adheres to surfaces of the rotor blades and the temperature of the decane rises, the decane vaporizes. At this moment, since the amount of heat of the rotor blades is consumed as heat of vaporization, the rotor blades can be cooled.

### CROSS-REFERENCE OF RELATED APPLICATION

This application is a Section 371 National Stage Application of International Application No. PCT/JP2019/050887, filed Dec. 25, 2019, which is incorporated by reference in its entirety and published as WO 2020/145150A1 on Jul. 16, 2020 and which claims priority of Japanese Application No. 2019-002971, filed Jan. 10, 2019.

### BACKGROUND OF THE INVENTION

The present invention relates to a vacuum pump, and particularly to a vacuum pump capable of not only preventing damage to a rotating body thereof by preventing overheating of the rotating body, but also exhausting a large amount of gas continuously.

With the recent development of electronics, the demand for semiconductors such as memories and integrated circuits has been increasing rapidly.

These semiconductors are each manufactured by doping an extremely pure semiconductor substrate with impurities to give electrical properties to the semiconductor substrate or by etching a fine circuit onto the semiconductor substrate.

These tasks need to be performed in a high vacuum chamber in order to avoid the impact of dust and the like in the air. Typically, a vacuum pump is used for exhausting such a chamber, and particularly a turbomolecular pump, a type of vacuum pump, is frequently used from the viewpoint of low residual gas, easy maintenance, and the like.

A semiconductor manufacturing process includes a large of number of steps in which a variety of process gases are caused to act on a semiconductor substrate; a turbomolecular pump is used not only to evacuate the chamber but also to exhaust these process gases from the chamber.

Incidentally, in some cases the process gases are introduced into the chamber at high temperature to increase the reactivities of the process gases.

When these process gases are cooled to a certain temperature when exhausted, the process gases become solid and may precipitate products in the exhaust system. In some cases these types of process gases become solid at a low temperature in the turbomolecular pump and stick to and accumulate inside the turbomolecular pump.

The accumulation of the precipitates of the process gases inside the turbomolecular pump narrows a pump flow path, leading to a decrease in performance of the turbomolecular pump.

In order to solve this problem, in the prior art, a heater or an annular water cooling pipe is wrapped around an outer circumference of a base portion or the like of a turbomolecular pump, and, for example, a temperature sensor is embedded in the base portion or the like, wherein heating by the heater or cooling by the water cooling pipe is controlled in such a manner that the temperature of the base portion is kept at a high temperature within a certain range on the basis of a signal from the temperature sensor.

The higher the control temperature, the more difficult it is for the products to accumulate. Thus, it is preferred that this temperature be as high as possible.

When the base portion is heated to a high temperature as described above, rotor blades may exceed a threshold temperature when an exhaust load fluctuates or the ambient temperature changes to a high temperature.

In this regard, in a vacuum pump with ball bearings, for example, since a rotating body and a stator part are in contact with each other at the bearing part, heat dissipation is expected to occur therefrom.

In a magnetic bearing vacuum pump, on the other hand, heat dissipation does not occur because a rotating body thereof is supported by magnetic force in a non-contact manner. Therefore, such vacuum pump faces the challenge of releasing the compression heat generated on the rotating body by the compression of a process gas, the frictional heat generated when the process gas comes into contact with or collide with the rotating body, and the heat generated by a motor of the vacuum pump.

In order to cope with this challenge, in the prior art, a high emissivity coating is applied to the rotor blades and stator blades to facilitate radiant heat transfer (see Japanese Patent Application Laid-Open No. 2005-320905). Alternatively, a spacer is provided between the inner circumferential surfaces of the rotor blades and the outer circumferential surface of the stator to reduce the gap therebetween, to facilitate heat dissipation through the gas (see Japanese Patent Application Laid-Open No. 2003-184785).

The discussion above is merely provided for general background information and is not intended to be used as an aid in determining the scope of the claimed subject matter. The claimed subject matter is not limited to implementations that solve any or all disadvantages noted in the background.

### SUMMARY OF THE INVENTION

Unfortunately, the radiant heat transfer described in Japanese Patent Application Laid-Open No. 2005-320905 and the heat dissipation through the gas described in Japanese Patent Application Laid-Open No. 2003-184785 are not enough to ensure a sufficient radiation amount. For this reason, in the prior art, the flow rate of the gas exhausted by the pump needs to be limited in order to prevent damage resulting from overheating of the rotating body, which makes it difficult to put the primary capacity of the pump to full use.

Particularly in recent years, in order to prevent the accumulation of reaction products in the pump as described above, pumps are configured such that the peripheral parts functioning as the flow paths are kept warm, which makes it more and more difficult to dissipate the heat from the rotating body to the peripheral parts.

The present invention was contrived in view of the foregoing problems of the prior art, and an object of the present invention is to provide a vacuum pump capable of not only preventing damage to a rotating body thereof by preventing overheating of the rotating body, but also exhausting a large amount of gas continuously.

Thus, the present invention (claim 1) is a vacuum pump comprising: an outer cylinder; a rotor blade contained in the outer cylinder, a rotor shaft attached to the rotor blade; a magnetic bearing supporting the rotor shaft in a levitated manner in the air; a rotary drive means for driving the rotor shaft to rotate; a stator disposed between the rotor blade and the rotor shaft; and an injection port disposed on the stator so as to face at least either the rotor blade or the rotor shaft, wherein liquid is ejected from the injection port to cool at least either the rotor blade or the rotor shaft with the liquid.

The injection port is disposed on the stator so as to face at least either the rotor blade or the rotor shaft. The liquid is ejected from the injection port. At least either the rotor blade or the rotor shaft is cooled by the liquid.

As a result, compression heat or frictional heat that is generated when the pump is operated can be removed, preventing overheating of the rotor blade and damage thereto.

In addition, a large amount of gas can be exhausted continuously, reducing the waiting time of a semiconductor manufacturing apparatus or a flat panel manufacturing apparatus and increasing the production output.

The present invention (claim 2) is the vacuum pump further comprising a supply port to which the liquid is supplied from the outside of the pump, and a communication passage connecting the supply port and the injection port.

The liquid is supplied from the outside of the pump through the supply port.

According to this configuration, the liquid can be delivered through the communication passage reliably with a simple structure.

The present invention (claim 3) is the vacuum pump in which the liquid has vapor pressure characteristics in which the liquid is in the form of liquid when ejected from the injection port and becomes a gas on a surface of at least either the rotor blade or the rotor shaft.

The temperatures of the rotor blade and the rotor shaft rotated by the rotary drive means are high. For this reason, the liquid adheres to the surface of the rotor blade or the rotor shaft and vaporizes when the temperatures of the surfaces thereof rise. At this moment, since the amount of heat on the rotor blade or the rotor shaft is consumed as heat of vaporization, the rotor blade or the rotor shaft can be cooled efficiently.

The present invention (claim 4) is the vacuum pump further comprising: a temperature detecting means for detecting a temperature of at least either the rotor blade or the rotor shaft; and a liquid injection amount control means for controlling the amount of the liquid to be ejected, on the basis of the temperature detected by the temperature detecting means.

The amount of the liquid to be ejected is controlled on the basis of the temperature detected by the temperature detecting means.

The amount of liquid consumed can be reduced by controlling the amount of the liquid to be ejected in accordance with the temperature of the rotor blade or the rotor shaft.

The present invention (claim 5) is the vacuum pump further comprising: an outlet port for exhausting a gas from the outer cylinder; a first pipe having one end thereof connected to the outlet port; and a cooling trap connected to the other end of the first pipe, wherein the cooling trap has a temperature thereof controlled to a temperature equal to or lower than a boiling point of the liquid at a pressure inside the cooling trap.

The cooling trap is cooled to a temperature equal to or lower than the boiling point of the liquid at the pressure inside the cooling trap.

Therefore, the gas that has vaporized inside the pump is liquefied again in the cooling trap and can easily be recovered by the cooling trap. The amount of liquid consumed can be reduced by reusing the recovered liquid.

The present invention (claim 6) is the vacuum pump further comprising: an outlet port for exhausting a gas from the outer cylinder; a first pipe having one end thereof connected to the outlet port; and a cooling trap connected to the other end of the first pipe, wherein the cooling trap has a front trap portion where a temperature of the cooling trap is controlled to a temperature higher than a boiling point of the liquid at a pressure inside the cooling trap, and a rear trap portion where the temperature of the cooling trap is controlled to a temperature equal to or lower than the boiling point of the liquid at the pressure inside the cooling trap, the rear trap portion being disposed downstream of the front trap portion.

The cooling trap includes the front trap portion and the rear trap portion. The temperature of the front trap portion is controlled to a temperature higher than the boiling point of the liquid at the pressure inside the outer cylinder. Thus, products inside the gas can be solidified. However, the gas that has vaporized inside the pump does not become liquefied at this moment. On the other hand, the temperature of the rear trap portion is controlled to a temperature equal to or lower than the boiling point of the liquid at the pressure inside the cooling trap. Therefore, the gas that has vaporized inside the pump is liquefied again by the cooling trap and can be recovered by the cooling trap easily and selectively. The amount of liquid consumed can be reduced by reusing the recovered liquid.

The present invention (claim 7) is the vacuum pump further comprising a transportation pump that recovers the liquid and supplies the recovered liquid to the injection port.

Therefore, the liquid can be reused efficiently and reliably.

The present invention (claim 8) is the vacuum pump further comprising a second pipe that includes a throttle portion that pressurizes the liquid to maintain a liquid state until the liquid is ejected from the injection port even at the pressure inside the outer cylinder.

By providing the second pipe with the throttle portion, the liquid state of the liquid can reliably be maintained until the liquid is ejected from the injection port even at the pressure inside the outer cylinder. As a result, efficient ejection can be achieved.

According to the present invention described above (claim 1), since the vacuum pump includes the injection port disposed on the stator so as to face at least either the rotor blade or the rotor shaft and is configured to eject the liquid from the injection port, at least either the rotor blade or the rotor shaft is cooled by the liquid.

As a result, compression heat or frictional heat that is generated when the pump is operated can be removed, preventing overheating of the rotor blade and damage thereto.

In addition, a large amount of gas can be exhausted continuously, reducing the waiting time of a semiconductor manufacturing device or a flat panel manufacturing device and increasing the production output.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a configuration diagram of a turbomolecular pump, which is an embodiment of the present invention;

FIG. 2 is a system configuration diagram of a method for recovering and reusing liquid;

FIG. 3 is a configuration diagram of a cooling trap; and

FIG. 4 is a configuration diagram of another embodiment of the present invention.

### DESCRIPTION OF THE PREFERRED EMBODIMENTS

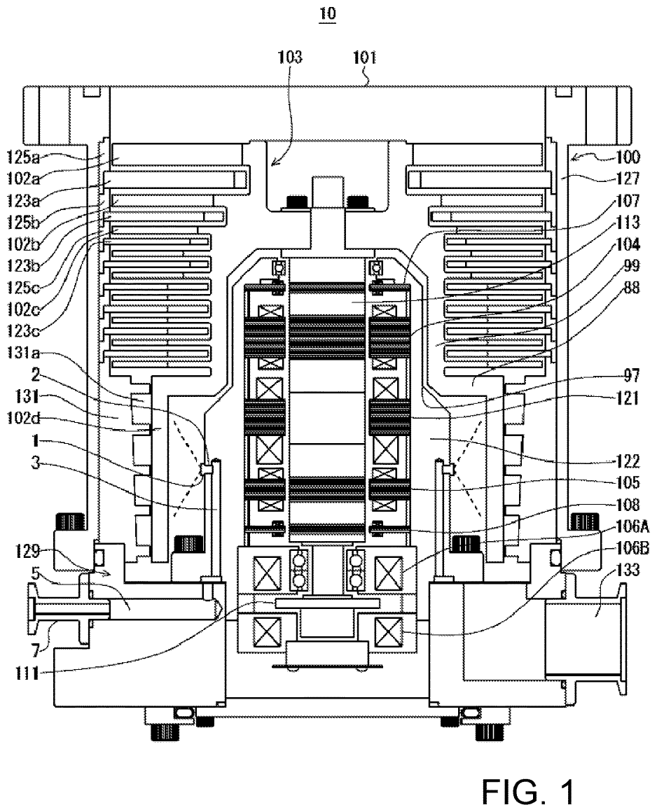

Embodiments of the present invention are described hereinafter. FIG. 1 shows a configuration diagram of a turbomolecular pump, an embodiment of the present invention.

In FIG. 1, an inlet port 101 is formed at an upper end of a cylindrical outer cylinder 127 of a pump body 100 of a turbomolecular pump 10. A rotating body 103 in which a plurality of rotor blades 102a, 102b, 102c, etc. are formed radially in multiple stages on a peripheral portion of a hub 99 is provided inside the outer cylinder 127, the rotor blades being configured as turbine blades for drawing and exhausting a gas.

A rotor shaft 113 is attached to the center of the rotating body 103. The rotor shaft 113 is supported in a levitated manner in the air and has the position thereof controlled by, for example, a so-called 5-axis control magnetic bearing.

Upper radial electromagnets 104 are four electromagnets arranged in pairs along an X-axis and a Y-axis that are radial coordinate axes of the rotor shaft 113 and are perpendicular to each other. Four upper radial displacement sensors 107 provided with coils are provided in the vicinity of the upper radial electromagnets 104 so as to correspond thereto. The upper radial displacement sensors 107 are configured to detect a radial displacement of the rotor shaft 113 and send the radial displacement to a controller, not shown.

On the basis of the displacement signal detected by the upper radial displacement sensors 107, the controller controls the excitation of the upper radial electromagnets 104 via a compensation circuit having a PID adjustment function, and adjusts an upper radial position of the rotor shaft 113.

The rotor shaft 113 is made of a high magnetic permeability material (such as iron) and configured to be attracted by the magnetic force of the upper radial electromagnets 104. Such adjustment is performed in an X-axis direction and a Y-axis direction independently.

Lower radial electromagnets 105 and lower radial displacement sensors 108 are arranged in the same manner as the upper radial electromagnets 104 and the upper radial displacement sensors 107, to adjust a lower radial position of the rotor shaft 113 as with the upper radial position of the rotor shaft 113.

Furthermore, axial electromagnets 106A and 106B are arranged so as to vertically sandwich a disc-shaped metal disc 111 provided under the rotor shaft 113. The metal disc 111 is made of a high magnetic permeability material such as iron.

Based on an axial displacement signal from an axial displacement sensor, which is not shown, the excitation of the axial electromagnets 106A and 106B is controlled via the compensation circuit of the controller that has the PID adjustment function. The axial electromagnet 106A and the axial electromagnet 106B use the magnetic forces thereof to attract the metal disc 111 upward and downward respectively.

In this manner, the control device is configured to appropriately adjust the magnetic forces of the axial electromagnets 106A and 106B acting on the metal disc 111 to cause the rotor shaft 113 to magnetically float in an axial direction and keep the rotor shaft 113 in the air in a non-contact manner.

A motor 121 has a plurality of magnetic poles that are circumferentially arranged so as to surround the rotor shaft 113. Each of the magnetic poles is controlled by the controller to drive the rotor shaft 113 to rotate by means of electromagnetic force acting between each magnetic pole and the rotor shaft 113.

A plurality of stator blades 123a, 123b, 123c, etc. are arranged with a small gap from the rotor blades 102a, 102b, 102c, etc. The rotor blades 102a, 102b, 102c, etc. are inclined at a predetermined angle from a plane perpendicular to the axis of the rotor shaft 113, in order to transfer molecules of exhaust gas downward by collision.

Similarly, the stator blades 123 are inclined at a predetermined angle from the plane perpendicular to the axis of the rotor shaft 113, and are arranged alternately with the stages of the rotor blades 102 in such a manner as to face inward of the outer cylinder 127.

Ends on one side of the respective stator blades 123 are fitted between and supported by a plurality of stacked stator blade spacers 125a, 125b, 125c, etc.

The stator blade spacers 125 are each a ring-like member and made of a metal such as aluminum, iron, stainless steel, copper, or an alloy containing these metals as components.

The outer cylinder 127 is fixed to an outer periphery of the stator blade spacers 125 with a small gap therefrom. A base portion 129 is disposed at a bottom portion of the outer cylinder 127, and a threaded spacer 131 is disposed between the bottom stator blade spacer 125 and the base portion 129. An outlet port 133 is formed under the threaded spacer 131 in the base portion 129 and communicated with the outside.

The threaded spacer 131 is a cylindrical member made of a metal such as aluminum, copper, stainless steel, iron, or an alloy containing these metals as components, and a plurality of thread grooves 131a are engraved in a spiral manner in an inner circumferential surface of the threaded spacer 131.

The direction of the spiral of the thread grooves 131a is a direction in which the molecules of the exhaust gas are transferred toward the outlet port 133 when moving in a direction of rotation of the rotating body 103.

An overhanging portion 88 is formed at a lower end of the hub 99 of the rotating body 103 horizontally in the radial direction, and a rotor blade 102d hangs down from a circumferential end of the overhanging portion 88. An outer circumferential surface of the rotor blade 102d is in a cylindrical shape, protrudes toward the inner circumferential surface of the threaded spacer 131, and is positioned in the vicinity of the inner circumferential surface of the threaded spacer 131 with a predetermined gap therefrom.

The base portion 129 is a disk-like member constituting a bottom portion of the turbomolecular pump 10 and typically made of a metal such as iron, aluminum, or stainless steel.

Since the base portion 129 physically holds the turbomolecular pump 10 and functions as a heat conducting path, it is preferred that a metal with rigidity and high thermal conductivity such as iron, aluminum, or copper be used as the base portion 129.

Also, in order to prevent the gas drawn in from the inlet port 101 from entering the electrical part constituted by the motor 121, the lower radial electromagnets 105, the lower radial displacement sensors 108, the upper radial electromagnets 104, the upper radial displacement sensors 107 and the like, the periphery of the electrical part is covered with a stator column 122 and the inside of the electrical part is maintained at a predetermined pressure by purge gas. The lower half of the stator column 122 below a bulging boundary point 97 has a larger diameter than the upper half of the same.

Four spray nozzles 1 are arranged circumferentially and evenly on a wall surface of the large-diameter portion of the stator column 122. It is preferred that an even number of spray nozzles 1 are evenly arranged. Four communication passages 3 communicating with the spray nozzles 1 are formed in the axial direction in a wall portion of the stator column 122. The four communication passages 3 are connected by an annular hole, not shown, which is formed inside the wall of the stator column 122. The communication passages 3 are connected to one end of a supply pipe 5 embedded in the base portion 129, and a supply port 7 is disposed at the other end of the supply pipe 5. The communication passages 3 and the supply pipe 5 each correspond to the second pipe.

The effects of the present embodiment are described next.

When the rotor blades 102 are driven by the motor 121 and rotate together with the rotor shaft 113, the exhaust gas from a chamber is sucked in through the inlet port 101 by the actions of the rotor blades 102 and the stator blades 123.

The exhaust gas sucked in through the inlet port 101 passes between the rotor blades 102 and the stator blades 123 and is transferred to the base portion 129. The exhaust gas is then ejected from the outlet port 133.

A chain saturated hydrocarbon such as decane (C₁₀H₂₂) is supplied from the supply port 7. This decane is sprayed from the spray nozzles 1 toward the rotor blade 102d via the supply pipe 5 and the communication passages 3. In other words, the decane is sprayed in the form of mist so as to easily vaporize on the surface of the rotor blade 102d.

Since decane has a boiling point of 174° C. at atmospheric pressure, the decane is a liquid at normal temperature and normal pressure. On the other hand, the pressure inside the turbomolecular pump 10 is in a substantially vacuum state of about 100 Pa, and the boiling point of the decane at this pressure is 14° C. Given the fact that the temperature of the rotor blades 102 may rise to approximately 150° C., the decane is assumed to be gas inside the pump.

Thus, although the pressure is high and the decane is in a liquid state until the decane is sprayed from the spray nozzles 1, when the decane adheres to surfaces of the rotor blades 102 and the temperature of the decane rises, the decane vaporizes. At this moment, since the amount of heat of the rotor blades 102 is consumed as heat of vaporization, the rotor blades 102 can be cooled efficiently.

It is preferred that throttle portions 2 be provided in the vicinity of the spray nozzles 1 so that the liquid does not vaporize before reaching the spray nozzles 1, and that the inside of the supply pipe 5 and the inside of the communication passages 3 be kept at or above the pressure at which the liquid gasifies.

In regard to the liquid that can be used in this case, the temperature at which the liquid gasifies at a working pressure may be equal to or lower than an allowable temperature of the rotor blades 102 so that the liquid vaporizes on the surfaces of the rotor blades 102. Therefore, other chain saturated hydrocarbons such as heptane and octane that have seven or more carbon atoms can be applied as well since these chain saturated hydrocarbons have substantially the same properties.

Note that a liquid that does not vaporize in the pump, such as vacuum oil, may be sprayed. Even in this case, a certain level of cooling effect can be expected.

It is preferred that the spray from the spray nozzles 1 spread over a wide range toward the rotor blade 102d. For this reason, the spray nozzles 1 are arranged substantially at the center of the height of the wall surface of the large-diameter portion of the stator column 122. However, the liquid may be squirted in a concentrated manner onto one section of the rotor blade 102d without being sprayed diffusely. In this case, the liquid is estimated to spread over the entire inner surface of the rotor blade 102d under the influence of the centrifugal force of the rotor blades 102.

Moreover, a temperature sensor detects that the temperature of the rotor blades 102 or the temperature of the rotor shaft 113 is equal to or higher than a predetermined temperature. In addition, a control function for turning the supply of the liquid ON/OFF on the basis of the signal from the temperature sensor may be provided. For example, the liquid is supplied when the temperature of the rotor blades 102 is 150° C. or higher, and the supply of the liquid is stopped when the temperature of the rotor blades 102 becomes 145° C. or lower.

The amount of liquid consumed can be reduced by controlling the amount of liquid to be supplied in accordance with the temperature of the rotor blades 102 or of the rotor shaft 113.

As a result, compression heat or frictional heat that is generated when the pump is operated can be removed, preventing overheating of the rotor blades and damage thereto.

In addition, a large amount of gas can be exhausted continuously, reducing the waiting time of a semiconductor manufacturing device or a flat panel manufacturing device and increasing the production output.

A method for recovering and reusing the liquid used for cooling the inside of the pump is described next.

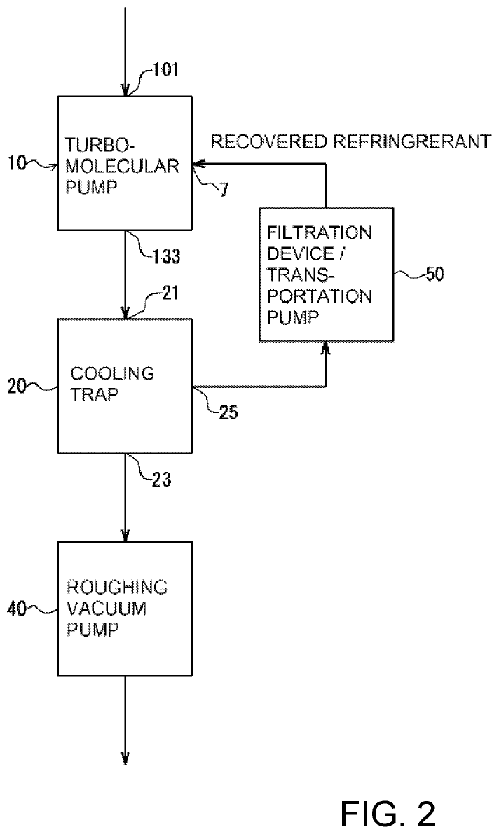

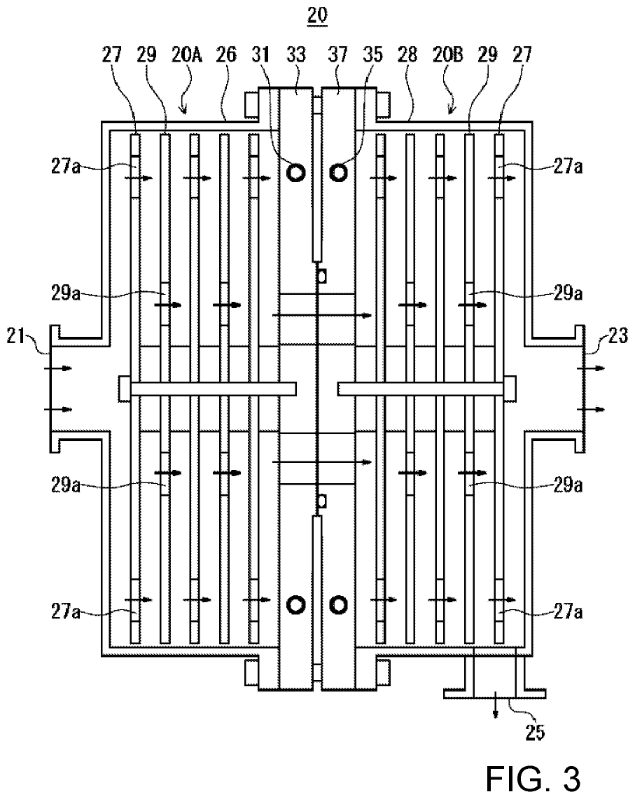

FIG. 2 shows a system configuration diagram of the method for recovering and reusing the liquid. In FIG. 2, the gas that has vaporized inside the pump is exhausted from the outlet port 133 together with the process gas to be exhausted. One end of the first pipe is connected to the outlet port 133. The other end of the first pipe is connected to an inlet port 21 of a cooling trap 20, whereby the gas flows into the inlet port 21 via the first pipe. A configuration diagram of the cooling trap 20 is shown in FIG. 3. In addition, a roughing vacuum pump 40 is connected to the outlet port 23 of the cooling trap 20, wherein the roughing vacuum pump 40 assists the pressure of the turbomolecular pump 10 to fall within an operating range.

A filtration device/transportation pump 50 is connected to a refrigerant discharge port 25 of the cooling trap 20, wherein the liquid filtered by the filtration device/transportation pump 50 is returned to the supply port 7 of the turbomolecular pump 10 and reused.

As shown in FIG. 3, the cooling trap 20 is provided with a front trap portion 20A and a rear trap portion 20B connected in series along a gas flow.

Inside an outer cylinder 26 of the front trap portion 20A, a disc-shaped cooling plate 27 with a plurality of holes 27a formed circumferentially and a disc-shaped cooling plate 29 with a plurality of holes 29a formed circumferentially are alternately arranged perpendicular to a traveling direction of the gas. The holes 27a are formed at positions away from the center of the outer cylinder 26, and the holes 29a are formed in the vicinity of the center of the outer cylinder 26. A water cooling portion 33 in which an annular water cooling pipe 31 is embedded is disposed at a rear end portion of the front trap portion 20A.

A water cooling portion 37 in which an annular water cooling pipe 35 is embedded is disposed at a front end portion of the rear trap portion 20B. Inside the outer cylinder 28 of the rear trap portion 20B, the disc-shaped cooling plate 27 and the disc-shaped cooling plate 29 are alternately arranged perpendicular to the traveling direction of the gas, as in the front trap portion 20A.

According to such a configuration, the cooling plate 27 and the cooling plate 29 are alternately stacked, causing the vaporized decane and the process gas to flow in a zigzag manner as shown by the arrows in FIG. 3. As a result, the areas where the gas comes into contact with the cooling plate 27 and the cooling plate 29 increase, thereby improving the cooling efficiency. The front trap portion 20A and the rear trap portion 20B are each provided with a thermometer, not shown, and are independently controlled to different temperatures on the basis of the temperatures measured by these thermometers.

The temperature of the front trap portion 20A is set at, for example, 40° C. At this set temperature, products in the process gas are precipitated in a solid form. Since the boiling point of the decane at this moment is 14° C. as described above, the decane does not liquefy but remains as a gas.

On the other hand, the set temperature of the rear trap portion 20B is set at, for example, 14° C. or lower, such as 10° C. Consequently, the decane liquefies in the rear trap portion 20B. The resultant liquid decane is discharged from the refrigerant discharge port 25. The liquid discharged from the refrigerant discharge port 25 is filtered by the filtration device/transportation pump 50 and reused in the turbomolecular pump 10. Since the decane liquefies again when cooled to 14° C. or lower in this manner, the decane can easily be recovered by the cooling trap 20. By reusing the recovered decane, the amount of decane consumed can be reduced. The remaining process gas is sent from the outlet port 23 of the cooling trap 20 to an external processing step, not shown, via the roughing vacuum pump 40.

In case of the configuration in which the vacuum oil is sprayed, since the liquid of the vacuum oil and the process gas are discharged from the outlet port 133, a T-shaped pipe may be disposed outside the outlet port 133 and the liquid may be reused by branching the vacuum oil with the T-shaped pipe.

Although not shown, a storage tank for storing the liquid of the vacuum oil in the pump may be prepared. Then, the liquid may be reused by sucking the liquid up from the storage tank using a small pump separately provided inside the turbomolecular pump 10 and spraying the liquid from the spray nozzles 1.

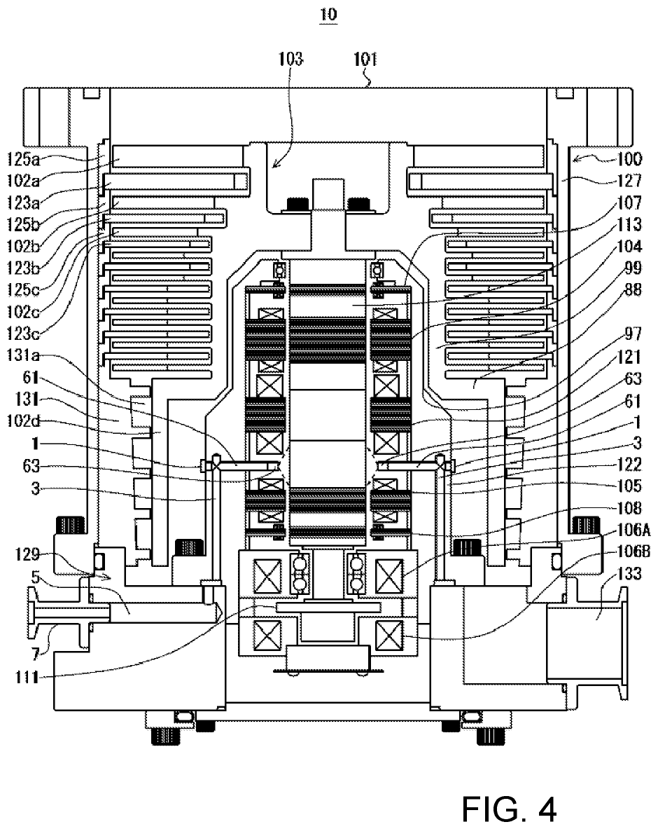

Also, in the present embodiment, the spray nozzles 1 are arranged on the outer peripheral side of the stator column 122, and the liquid is sprayed from the spray nozzles 1 toward the rotor blade 102d. However, as shown in the configuration diagram of another embodiment of the present invention in FIG. 4, communication passages 61 connected to the communication passages 3 may be extended in the radial direction, and spray nozzles 63 may also be arranged on the inner peripheral side of the stator column 122. In this case, the liquid is sprayed from the spray nozzles 1 toward the rotor blade 102d, and sprayed from the spray nozzles 63 toward the rotor shaft 113.

In this manner, both the rotor blades 102 and the rotor shaft 113 can be cooled at once. However, only either the rotor blades 102 or the rotor shaft 113 may be cooled.

Note that various modifications can be made to the present invention without departing from the spirit of the present invention, and it goes without saying that the present invention extends to such modifications.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump, comprising:
an outer cylinder;
a rotor blade contained in the outer cylinder;
a rotor shaft attached to the rotor blade;
a magnetic bearing supporting the rotor shaft in a levitated manner in the air;
a rotary drive means for driving the rotor shaft to rotate;
a stator disposed between the rotor blade and the rotor shaft; and
an injection port disposed on the stator so as to face at least either the rotor blade or the rotor shaft,
wherein liquid is ejected from the injection port to cool at least either the rotor blade or the rotor shaft with the liquid.

2. The vacuum pump according to claim 1, further comprising:
a supply port to which the liquid is supplied from the outside of the pump; and
a communication passage connecting the supply port and the injection port.

3. The vacuum pump according to claim 1, wherein the liquid has vapor pressure characteristics in which the liquid is in the form of liquid when ejected from the injection port and becomes a gas on a surface of at least either the rotor blade or the rotor shaft.

4. The vacuum pump according to claim 1, further comprising:
a temperature detecting means for detecting a temperature of at least either the rotor blade or the rotor shaft; and
a liquid injection amount control means for controlling the amount of the liquid to be ejected, on the basis of the temperature detected by the temperature detecting means.

5. The vacuum pump according to claim 1, further comprising:
an outlet port for exhausting a gas from the outer cylinder;
a first pipe having one end thereof connected to the outlet port; and
a cooling trap connected to the other end of the first pipe,
wherein the cooling trap has a temperature thereof controlled to a temperature equal to or lower than a boiling point of the liquid at a pressure inside the cooling trap.

6. The vacuum pump according to claim 1, further comprising:
an outlet port for exhausting a gas from the outer cylinder;
a first pipe having one end thereof connected to the outlet port; and
a cooling trap connected to the other end of the first pipe,
wherein the cooling trap has:
a front trap portion where a temperature of the cooling trap is controlled to a temperature higher than a boiling point of the liquid at a pressure inside the cooling trap; and
a rear trap portion where the temperature of the cooling trap is controlled to a temperature equal to or lower than the boiling point of the liquid at the pressure inside the cooling trap, the rear trap portion being disposed downstream of the front trap portion.

7. The vacuum pump according to claim 1, further comprising a transportation pump that recovers the liquid and supplies the recovered liquid to the injection port.

8. The vacuum pump according to claim 1, further comprising a second pipe that includes a throttle portion that pressurizes the liquid to maintain a liquid state until the liquid is ejected from the injection port even at the pressure inside the outer cylinder.
